(19) United States
(12) Patent Application Publication
(10) Pub. No.: US 2026/0250444 A1
(43) Pub. Date: Aug. 27, 2026

(54) POLYMER, COMPOSITION AND THEIR USE

(71) Applicant: MAFLON S.P.A., Milano (MI) (IT)

(72) Inventors: Camillo ZARANTONELLO, Milano (MI) (IT); Francesco MANIERO, Milano (MI) (IT)

(21) Appl. No.: 19/160,201

(22) PCT Filed: Mar. 25, 2024
(86) PCT No.: PCT/IB2024/052848

§ 371 Date: Aug. 27, 2025

(30) Foreign Application Priority Data
Mar. 24, 2023 (IT) 102023000005658

(51) Int. Cl. C08F 220/28; C09D 5/16; C09D 7/40; C09D 7/61; C09D 7/65; C09D 133/14; D06M 15/643; D06M 101/06; D06M 101/34

(52) U.S. Cl. CPC C08F 220/282; C09D 5/1668; C09D 7/61; C09D 7/65; C09D 7/67; C09D 133/14; D06M 15/643; D06M 2101/06; D06M 2101/34; D06M 2200/01; D06M 2200/11; D06M 2200/12

(57) ABSTRACT

The present invention concerns a polymer obtained by a polymerization between at least: (A) or a combination of (A) and (B); and at least two selected from (C), (D), (E), optionally (F), and combinations thereof. Furthermore, the object of the present invention is a composition comprising said polymer, and a use of said polymer or of said composition as a water-repellent and/or oil-repellent agent, and/or as an anti-stain agent, and/or as an anti-graffiti agent, of a substrate.

### FIELD OF THE INVENTION

The invention lies in the field of water-repellent and/or oil-repellent agents, anti-stain agents and/or anti-graffiti agents.

### PRIOR ART

Fluorinated materials dominate the anti-stain applications for construction products, textiles, leather and paper thanks to their excellent water-phobicity and oil-phobicity.

To date, most of the best-performing anti-stain solutions are still based on fluorine chemistry. Highly water-repellent and oil-repellent coatings are used all over the world in everyday life and in the industrial and research sectors, such as self-cleaning, antifreeze and anti-biofouling.

Persistence, degradation and transformation of the environment caused by fluorinated compounds raise concerns about medium- and long-term effects on human health and wildlife. For these reasons, efforts to reduce the impact of such compounds are increasing.

Since fluorine-containing substances and fluoropolymers in various applications could release materials such as perfluoroalkylcarboxylates or perfluoroalkylsulfonates into the environment, ECHA (European Chemicals Agency) has issued a number of strict regulations on fluorine-containing substances.

Fluorinated compounds that are currently subject to restrictions are perfluorooctanesulfonic acid (PFOS), perfluorooctanoic acid (PFOA), perfluorocarboxylic acids with a chain consisting of 9-14 carbon atoms (C9-C14 PFCAs), salts thereof and correlated substances.

The use of other fluorinated compounds—undecafluorohexanoic acid (PFHxA), perfluorohexanesulfonic acid (PFHxS), perfluorinated compounds-CF2 (PFAS), and salts thereof and compounds derived therefrom—will be restricted or prohibited in the near future.

Such materials could, in fact, remain in the environment and ecosystem and are suspected of being highly toxic.

WO 2016/163435 A1, EP 2 794 725 B1 and WO 2009/065004 A2 belong to the prior art.

The Applicant, after a long and intense research and development activity, has developed a polymer and a composition able to provide an adequate response to the existing limits, drawbacks and problems. In particular, the Applicant has developed a new non-fluorinated polymer (“fluorine-free”) that can reduce, or even avoid, environmental and health problems related to fluorine chemistry without sacrificing characteristics of water-phobicity and/or oil-phobicity.

Therefore, the object of the present invention is a polymer having the characteristics of the appended claims.

Furthermore, the object of the present invention is composition comprising said polymer, having the characteristics of the appended claims.

Furthermore, the object of the present invention is a use of said polymer or of said composition, having the characteristics of the appended claims.

The object of the present invention is a polymer obtained by a polymerization between at least:
(A) or a combination of (A) and (B); and
at least one selected from (C), (D), (E), optionally (F), and combinations thereof;
wherein:
(A) is a compound of general formula (A.I) or (A.II), or a mixture of (A.I) and (A.II):

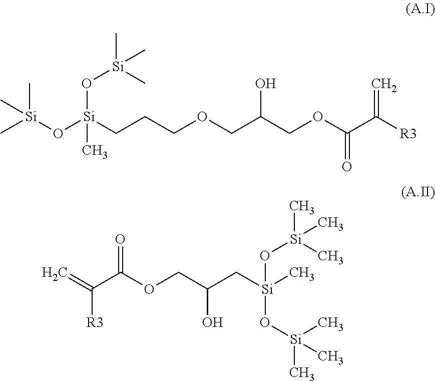

wherein R3 is independently hydrogen or methyl;
(B) is a compound of general formula (B.I) or (B.II), or a mixture of (B.I) and (B.II):

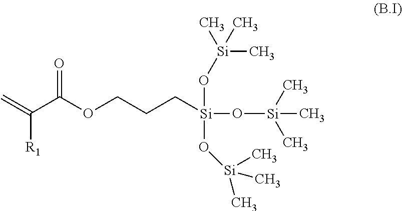

wherein R¹ is hydrogen or methyl;

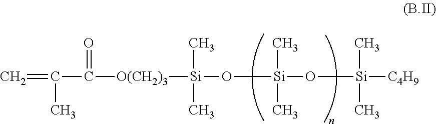

wherein n is an integer comprised from 3 to 15, preferably from 3 to 10;
(C) is at least one selected from the group consisting of: (met) acrylic acid, α-chloro-acrylic acid, crotonic acid, maleic acid, fumaric acid and itaconic acid, monomers including a hydroxyl group, e.g. 2-hydroxyethyl (met)acrylate and 2-hydroxypropyl (met)acrylate, hydroxybutyl (met)acrylate, 3-chloro-2-hydroxypropyl methacrylate, poly(ethylene glycol) mono(meth)acrylate, poly(propylene glycol) mono(methacrylate), poly(ethylene glycol)-co-poly(propylene glycol) mono(methacrylate), polytetrahydrofuran mono(methacrylate), N-hydroxymethyl(methacrylamide), hydroxybutylvinyl ether, N-hydroxymethyl (meth)acrylamide, vinyl (meth)acrylate, allyl (meth)acrylate, N-methoxymethylacrylamide, N-isopropoxy-methylacrylamide, N-butoxy-methylacrylamide N-isobutoxy-methylacrylamide, glycidyl (meth)acrylate, 2-carboxyethyl acrylate, and (α,α-dimethyl-m-isopropenylbenzyl) isocyanate, alkyl (meth)acrylate compounds terminated with an isocyanate group blocked by phenol, ketoxime, pyrazole and mixtures thereof;
(D) is a compound of general formula (D.I):

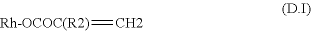

wherein:
R2 is hydrogen or methyl;
Rh is a benzyl radical or an alkyl radical, linear or branched, comprising from 1 to 30 carbon atoms, preferably an alkyl radical comprising from 1 to 20 carbon atoms;
(E) is a compound of general formula (E.I):

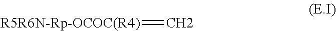

wherein:
R4 is hydrogen or methyl;
Rp is an alkylene radical comprising from 1 to 10 carbon atoms optionally substituted with at least one hydroxyl and/or halogen group;
R5, R6 are independently hydrogen, a benzyl radical or an alkyl radical, linear or branched, comprising from 1 to 10 carbon atoms;
(F) is at least one selected from the group consisting of: vinyl acetate, vinyl propionate, vinyl isobutyrate, vinyl pivalate, vinyl 2-ethylhexanoate, vinyl stearate, N-vinyl pyrrolidinone, vinyl chloride, vinylidene chloride, trimethyl vinyl silane, trimethoxy vinyl silane, triethoxy vinyl silane, and mixtures thereof.

It should be noted that, in this description, the expressions “(meth)acrylic” and “(meth)acrylate”, or expressions similar to them, mean “acrylic or methacrylic” and “acrylate or methacrylate”, respectively. In addition, the compounds listed in this description also comprise the relative isomers even where not expressly indicated.

Preferably, said polymer obtained by a polymerization between at least:
(A) or a combination of (A) and (B); and
at least two, or at least three, or at least four, selected from (C), (D), (E), optionally (F), and combinations thereof.

More preferably, said polymer is obtained by a polymerization between at least:
(A) and (C) or a combination of (A), (B), and (C); and
at least one, or at least two, or at least three, selected from (D), (E), optionally (F), and combinations thereof.

(A) or (A) and (B) have structural characteristics suitable for exerting a high level of surface activity, comparable to the level of activity generated by a short-chain perfluorinated type group, while avoiding the disadvantages related to fluorine chemistry.

(C) contains one or more crosslinkable groups.

A crosslinkable group is a functional group capable of reacting with a substrate and/or with a further polyfunctional compound added. Such crosslinkable groups may be: carboxylic acid groups, ethylenically unsaturated groups, hydroxyl groups, amino groups, N-alkylolamide groups, isocyanate or protected isocyanate groups.

Preferably, (C) is selected from the group consisting of: glycidyl (meth)acrylate, (meth)acrylic acid, itaconic acid, vinyl (meth)acrylate, allyl (meth)acrylate, 2-hydroxyethyl (meth)acrylate, 2-hydroxypropyl (meth)acrylate, hydroxybutyl (meth)acrylate, poly(ethylene glycol) mono(meth)acrylate, N-hydroxymethyl (meth)acrylamide, N-methoxymethylacrylamide, N-isopropoxymethylacrylamide, 2-carboxyethyl acrylate, and mixtures thereof.

(D) has the function of improving the water-repellency and, at the same time, must have characteristics such as not to compromise the oil-repellency markedly.

(D) is preferably selected from the group consisting of: methyl (meth)acrylate, ethyl (meth)acrylate, propyl (meth)acrylate, butyl (meth)acrylate, isobutyl (meth)acrylate, t-butyl (meth)acrylate, pentyl (meth)acrylate, hexyl (meth)acrylate, eptyl (meth)acrylate, 2-ethylhexyl (meth)acrylate, octyl (meth)acrylate, nonyl (meth)acrylate, decyl (meth)acrylate, isobornyl (meth)acrylate, lauryl (meth)acrylate, stearyl (meth)acrylate, cyclohexyl (meth)acrylate, tridecyl (meth)acrylate, behenyl (meth)acrylate, a longer chain (meth)acrylate than C18, and mixtures thereof.

More preferably, (D) is selected from the group consisting of: decyl (meth)acrylate, isobornyl (meth)acrylate, lauryl (meth)acrylate, stearyl (meth)acrylate, cyclohexyl (meth)acrylate, tridecyl (meth)acrylate, behenyl (meth)acrylate, and mixtures thereof.

(E)—suitably formulated—can be used to modulate the characteristics of water-repellency and oil-repellency. In water-based compositions this monomer can be salted to bring the product into aqueous liquid solution (compatibilizing function).

Preferably, (E) is selected from the group consisting of 2-dimethylamino ethyl (meth)acrylate, 2-diethylamino ethyl (meth)acrylate, 2-(tert-butylamino)ethyl (meth)acrylate, and mixtures thereof.

A possible function of (F) is, by way of example, a fixative particularly used in the textile sector. Nevertheless, N-vinyl pyrrolidinone-which is among the monomers (F)-could have different or additional functions compared to acting as a fixative, for example to improve water-repellency.

Preferably (F) is selected from N-vinyl pyrrolidinone, vinyl chloride, vinylidene chloride, and mixtures thereof.

In accordance with a preferred embodiment:
(A) is the compound of general formula (A.I), wherein R³ is preferably methyl;
(B) is the compound of general formula (B.I), wherein R¹ is preferably methyl;
(C) is selected from 2-hydroxyethyl acrylate, 2-hydroxyethyl methacrylate, 2-hydroxypropyl acrylate, 2-hydroxypropyl methacrylate, hydroxybutyl acrylate, hydroxybutyl methacrylate, glycidyl methacrylate, acrylic acid, methacrylic acid, 2-carboxyethyl acrylate, and mixtures thereof;
(D) is at least one selected from the group consisting of: decyl (meth)acrylate, isobornyl (meth)acrylate, lauryl (meth)acrylate, stearyl (meth)acrylate, cyclohexyl (meth)acrylate, tridecyl (meth)acrylate, behenyl (meth)acrylate, a longer chain (meth)acrylate than C18, and mixtures thereof; more preferably wherein (D) is stearyl (meth)acrylate, tridecyl methacrylate, or a mixture thereof, or behenyl (meth)acrylate, even more preferably wherein (D) is stearyl (meth)acrylate or behenyl (meth)acrylate;
in the compound of general formula (E.I): Rp is an alkylene radical comprising from 2 to 5 carbon atoms, and R5, R6 are independently hydrogen, or an alkyl radical, linear or branched, comprising from 1 to 5 carbon atoms, more preferably wherein (E) is selected from 2-dimethylamino ethyl acrylate, 2-dimethylamino ethyl methacrylate, 2-diethylamino ethyl acrylate, 2-diethylamino ethyl methacrylate, and mixtures thereof.

In this description the term “behenyl (meth)acrylate” means a mixture of:
octadecyl acrylate (CAS No. 4813-57-4) and/or octadecyl methacrylate (CAS No. 32360 May 7) in an amount comprised from 40% to 44% by weight;
icosyl acrylate (CAS No. 48076-38-6) and/or icosyl methacrylate (CAS No. 45294-18-6) in an amount comprised from 9% to 13% by weight;
docosyl acrylate (CAS No. 18299-85-9) and/or docosyl methacrylate (CAS No. 16669-27-5) in an amount comprised from 42% to 46% by weight;
hexadecyl acrylate (CAS No. 13402-02-3) and/or hexadecyl methacrylate (CAS No. 2495-27-4) in an amount comprised from 0.3% to 1.5% by weight.

Preferably, the behenyl (meth)acrylate comprises or consists of a mixture of said acrylates in the indicated amounts.

Regarding the amounts of (A)-(F), preferably in said polymer (the following amounts being expressed as a percentage by weight of the individual compound with respect to the total weight of (A)-(F)):
(A) is comprised from 10% to 90% by weight, preferably comprised from 30% to 80% by weight, more preferably comprised from 45% to 75% by weight;
(B) is comprised from 0% to 30% by weight, preferably comprised from 2% to 23% by weight, more preferably comprised from 5% to 22% by weight;
(C) is comprised from 0.1% to 30% by weight, preferably comprised from 1% to 20% by weight, more preferably comprised from 1.5% to 17% by weight;
(D) is comprised from 0% to 50% by weight, preferably comprised from 3% to 35% by weight, more preferably comprised from 7% to 33% by weight;
(E) is comprised from 0% to 25% by weight, preferably comprised from 2% to 20% by weight, more preferably comprised from 3% to 15% by weight;
(F) is comprised from 0% to 15% by weight, preferably comprised from 0% to 10% by weight, more preferably comprised from 0% to 8% by weight.

According to a preferred embodiment, said polymer comprises or consists of: (A.I). optionally (B.I), (C), optionally (D), optionally (E), optionally (F) and, preferably, comprises, or consists of: (A.I). optionally (B.I), (C), (D), optionally (E), optionally (F) and, more preferably, comprises, or consists of: (A.I). (B.I), (C), (D), optionally (E), optionally (F).

According to a particularly preferred embodiment, said polymer comprises or consists of the following compounds in the amounts indicated in the following Table 1.A:

TABLE 1.A

| | | |
|---|---|---|
| (A.I) | (3-methacryloxy-2- | from 10% to 90% by |
| | hydroxypropoxy)propylbis(trimethylsiloxy) | weight, preferably from |
| | methylsilane (CAS No. 69861-02-5); | 30% to 80% by weight, |
| | | more preferably from |
| | | 45% to 75% by weight |
| (B.I) | optionally: | from 0% to 30% by |
| | 3-[tris(trimethylsiloxy)silyl]propyl | weight, preferably from |
| | methacrylate (CAS No. 17096-07-0); | 2% to 23% by weight, |
| | | more preferably from |
| | | 5% to 22% by weight |
| (C) | 2-hydroxypropyl acrylate (CAS No. 923-26- | from 0.1% to 30% by |
| | 2) or 2-hydroxypropyl methacrylate (CAS | weight, preferably from |
| | No. 868-77-9) or glycidyl methacrylate, or 2- | 1% to 20% by weight, |
| | carboxyethyl acrylate (CAS No. 24615-84- | more preferably from |
| | 7), or methacrylic acid, or a mixture of 2- | 1.5% to 17% by weight |
| | hydroxyethyl methacrylate and glycidyl | |
| | methacrylate, or a mixture of glycidyl | |
| | methacrylate and 2-hydroxyethyl | |
| | methacrylate, or a mixture of methacrylic | |
| | acid and 2-carboxyethyl acrylate; | |
| (D) | optionally: | from 0% to 50% by |
| | stearyl methacrylate (CAS No. 32360-05-7), | weight, preferably from |
| | stearyl acrylate (CAS No. | 3% to 35% by weight, |
| | 4813-57-4), tridecyl methacrylate, tridecyl | more preferably from |
| | acrylate, butyl methacrylate, butyl acrylate, | 7% to 33% by weight |
| | or any combination thereof, or behenyl | |
| | (meth)acrylate, or a mixture of behenyl | |
| | (meth)acrylate and methyl (meth)acrylate; | |
| | preferably stearyl methacrylate, or a mixture | |
| | of stearyl methacrylate and tridecyl | |
| | methacrylate, or behenyl (meth)acrylate, or a | |
| | mixture of behenyl (meth)acrylate and | |
| | methyl (meth)acrylate, or a mixture of butyl | |
| | (meth)acrylate and stearyl (meth)acrylate; | |
| (E) | optionally: | from 0% to 25% by |
| | 2-dimethylamino ethyl acrylate (CAS No. | weight, preferably from |
| | 2439-35-2), 2-dimethylamino ethyl | 1% to 20% by weight, |
| | methacrylate (CAS No. 2867-47-2), 2- | more preferably from |
| | diethylamino ethyl acrylate (CAS No. 2439- | 3% to 15% by weight |
| | 35-2), 2-diethylamino ethyl methacrylate | |
| | (CAS No. 105-16-8), or mixtures thereof; | |
| (F) | optionally N-vinyl pyrrolidinone (CAS No. | from 0% to 15% by |
| | 88-12-0) or vinylidene chloride (CAS No. | weight, preferably |
| | 75-35-4); | comprised from 0% to |
| | | 10% by weight, more |
| | | preferably comprised |
| | | from 0% to 8% by |
| | | weight |

More preferably, said polymer comprises or consists of the following compounds in the amounts indicated in the following Table 1.B or Table 1.C or Table 1.D or Table 1.E:

TABLE 1.B

| | | |
|---|---|---|
| (A.I) | (3-methacryloxy-2- | from 45% to 75% |
| | hydroxypropoxy)propylbis(trimethylsiloxy) | by weight |
| | methylsilane | |
| (B.I) | 3-[tris(trimethylsiloxy)silyl]propyl | from 5% to 22% |
| | methacrylate | by weight |
| (C) | 2-hydroxypropyl methacrylate or | from 3% to 16% |
| | methacrylic acid | by weight |
| (D) | a mixture of stearyl methacrylate and | from 7.5% to 23% |
| | tridecyl methacrylate, or stearyl | by weight |
| | methacrylate | |
| (E) | 2-dimethylamino ethyl acrylate or 2- | from 3% to 15% |
| | dimethylamino ethyl methacrylate | by weight |

TABLE 1.C

| | | |
|---|---|---|
| (A.I) | (3-methacryloxy-2- | from 50% to 60% |
| | hydroxypropoxy)propylbis(trimethylsiloxy) | by weight |
| | methylsilane | |
| (B.I) | 3-[tris(trimethylsiloxy)silyl]propyl | from 7% to 19% |
| | methacrylate | by weight |
| (C) | a mixture of 2-hydroxyethyl methacrylate | from 1.5% to 8% |
| | and glycidyl methacrylate; | by weight |
| (D) | behenyl (meth)acrylate | from 20% to 32% |
| | | by weight |

TABLE 1.D

| | | |
|---|---|---|
| (A.I) | (3-methacryloxy-2- | from 50% to 60% |
| | hydroxypropoxy)propylbis(trimethylsiloxy) | by weight |
| | methylsilane | |
| (B.I) | 3-[tris(trimethylsiloxy)silyl]propyl | from 7% to 19% |
| | methacrylate | by weight |
| (C) | a mixture of glycidyl methacrylate and 2- | from 1.5% to 8% |
| | hydroxyethyl methacrylate; | by weight |
| (D) | a mixture of behenyl (meth)acrylate and | from 20% to 32% |
| | methyl (meth)acrylate, preferably in a | by weight |
| | weight ratio comprised from 5:1 to 1:1, more | |
| | preferably comprised from 3:1 to 1:1; | |

TABLE 1.E

| | | |
|---|---|---|
| (A.I) | (3-methacryloxy-2- | from 45% to 75% |
| | hydroxypropoxy)propylbis(trimethylsiloxy) | by weight |
| | methylsilane | |
| (C) | 2-hydroxypropyl (meth)acrylate | from 3% to 16% |
| | | by weight |
| (D) | a mixture of stearyl (meth)acrylate and butyl | from 7.5% to 23% |
| | (meth)acrylate | by weight |
| (E) | 2-dimethylamino ethyl acrylate or 2- | from 3% to 15% |
| | dimethylamino ethyl methacrylate | by weight |

Said polymerization is preferably radical in the organic or aqueous liquid phase (preferably in dispersion or in (micro-) emulsion), in an inert atmosphere (for example in a nitrogen atmosphere) and in the presence of at least one radical initiator of the organic or inorganic peroxide or hydroperoxide type, azo, or initiator activatable by UV rays, and optionally of a redox initiator.

Preferably, said radical initiator is selected from the group consisting of: benzoyl peroxide, lauroyl peroxide, acetyl peroxide, succinyl peroxide, tert-thiobutyl perpivalate; cumene hydroperoxide, t-butyl hydroperoxide, t-amyl hydroperoxide, di-t-butyl peroxide, dicumyl peroxide; ammonium persulfate, potassium persulfate; azo-2,2-bis(isobutyronitrile), azo-2,2-bis-(2,4-dimethyl-4-methoxy-valeronitrile), azo-4-4-bis-(4-cyanopentanoic) acid, azodicarbonamide; benzophenone, 2-methyl-anthraquinone or 2-chloro-thioxanthone, and mixtures thereof.

More preferably, said radical initiator is 2,2′-azobis(isobutyronitrile) (AIBN) or 2,2′-azobis(2-methylpropionamidine) dihydrochloride.

Said redox initiator, when present, is mainly employed at the end of the process to complete the reaction and reduce the concentration of unreacted monomers.

Preferably, said redox initiator is a mixture of a sodium salt of hydroxymethyl sulinic acid, a disodium salt of 2-hydroxy-2-sulfinatoacetic acid in combination with an oxidizing agent such as hydrogen peroxide, or tert-butyl hydroperoxide, or ammonium persulfate. Such a mixture is for example obtainable as Bruggolite® E28 (Bruggemann Chemicals; Heilbronn; Germany).

An amount of said radical initiator is preferably comprised from 0.01% to 5% by weight, more preferably from 0.1 to 1.5% by weight, with respect to the total weight of the compounds from (A) to (F).

A temperature of said polymerization is preferably comprised from 40° C. to 90° C., preferably comprised from 45° C. to 60° C. or from 60° C. to 85° C.

In accordance with one embodiment, downstream of the polymerization, one or more technological additives—illustrated below—are homogeneously mixed with the polymer still in the liquid phase.

In accordance with another embodiment, downstream of the polymerization in the presence of a first organic solvent, a second solvent is added, and subsequently the first organic solvent is at least partially removed by distillation. The second solvent, preferably high boiling (T^{e}>70° C.; suitable to be transported and/or applied safely) keeps the polymer in solution/emulsion. The second solvent may be organic or may be water.

One or more surfactants and optionally one or more organic co-solvents may optionally be used in the polymerization if the liquid phase is aqueous. By way of example, the surfactants are selected from the following, eventually usable individually or in combination with each other:
non-ionic surfactants;
cationic surfactants;
anionic surfactants;
amphoteric surfactants (for example: dodecyl betaine or aminocarboxylic acids).

Preferably, the surfactants are present in an amount comprised from 0.1% to 100% by weight with respect to the weight of the monomers.

Said nonionic surfactant is preferably selected from the group consisting of: poly(ethylene glycol) lauryl ether, poly(ethylene glycol) tridecyl ether, poly(ethylene glycol) cetyl ether, poly (ethylene glycol)-co-poly(propylene glycol) cetyl ether, poly(ethylene glycol) stearyl ether, poly(ethylene glycol) oleyl ether, poly(ethylene glycol) nonylphenol ether, poly (ethylene glycol) octylphenol ether, poly(ethylene glycol) monolaurate, poly(ethylene glycol) monostearate, poly(ethylene glycol) monooleate, sorbitan monolaurate, sorbitan monostearate, sorbitan monopalmitate, sorbitan monostearate, sorbitan monooleate, sorbitan sesquioleate, sorbitan trioleate, poly(ethylene glycol) sorbitan monolaurate, poly(ethylene glycol) sorbitan monopalmitate, poly(ethylene glycol) sorbitan monostearate, poly(ethylene glycol) sorbitan monooleate, poly(ethylene glycol)-co-poly(propylene glycol), fatty acid esters of polyglycerol, polyether-modified silicone oils and perfluoroalkyl ether adducts, and mixtures thereof.

Said cationic surfactant is preferably selected from the group consisting of: ammonium compounds based on amines of saturated and unsaturated fatty acids, for example octadecylammonium acetate, dodecyltrimethylammonium chloride; ammonium compounds based on amino-functionalized polyethoxylates and polypropoxylates and interpolymers thereof, such as for example polyoxyethylene laurylmonomethylammonium chloride; ammonium compounds based on arylamines, such as for example biphenyltrimethylammonium chloride, imidazoline derivatives, such as for example ammonium salts formed by tallow and imidazoline; cationic surfactants based on silicone and cationic surfactants based on fluorine.

Said anionic surfactant is preferably selected from the group consisting of: fatty alcohol sulphates, for example sodium dodecyl sulphate and poly(ethylene glycol) lauryl ether sulphate; alkyl sulphonates, for example sodium lauryl sulphonate; alkyl benzene sulphonates, such as for example the sulphates of nonyl phenol ether, sulphosuccinates, such as for example sodium sulphosuccinate hexyl diether; fatty alcohol phosphates, such as for example sodium lauryl phosphate and fatty acid salts, such as for example the sodium salt of stearic acid.

Liquid phases (solvents and/or co-solvents) with a boiling point of less than 120° C. are preferably used in the polymerization. By way of example, ketones, polyalcohols, glycols, esters, and hydrocarbons.

By way of further example, the solvents are selected from the group consisting of: ketones, such as for example acetone, methyl ethyl ketone and methyl isobutyl ketone; alcohols, such as for example ethanol, isopropanol and butanol, polyalcohols, such as for example 1,3-butanediol, 1,6-hexanediol, ethylene glycol, propylene glycol, dipropylene glycol, tripropylene glycol and glycerol; ethers and esters of polyalcohols, such as for example dipropylene glycol monomethyl ether, tripropylene glycol monomethyl ether, triethylene glycol dimethyl ether and diethylene glycol monobutyl ether acetate; esters, such as for example ethyl acetate, propyl acetate, butyl acetate, dibutyl adipate and dibutyl succinate; hydrocarbons and halogenated hydrocarbons, such as for example toluene, xylene, octane, perchloroethylene and 1,3-dichloro-2,2,3,3,3-pentluoropropane.

One or more chain transfer agents, such as alkylmercaptans (e.g.: n-dodecylmercaptan, n-octylmercaptan, tert-thio-dodecylmercaptan) may optionally be used in the polymerization. The amounts of the chain transfer agents are preferably comprised from 0.01% to 3% by weight, preferably from 0.05% to 0.5% by weight, with respect to the total weight of the compounds (A)-(F).

Downstream the polymerization, the polymer preparation could comprise an addition of diisocyanates or polyisocyanates to increase the molecular weight of the polymer, in the presence of at least one suitable non-aqueous solvent and of at least one catalyst such as bismuth neodecanoate, bismuth tris(2-ethylhexanoate), and zinc (II) acetylacetonate, 1,4-diazabicyclo[2.2.2]octane (DABCO). Said isocyanates are preferably selected from the group consisting of:
(a) 1,5-pentamethylene diisocyanate (PDI) and polymers thereof, preferably trimers, optionally biological-based;
(b) toluene diisocyanate (TDI) and adducts thereof, preferably TDI trimers;
(c) polyisocyanates derived from hexamethylenediisocyanate (HDI) obtained by means of trimerization, biuretization and/or allophanatization process/es;
(d) polyisocyanates derived from isophorone diisocyanate (IPDI) obtained by means of trimerization, biuretization and/or allophanatization process/es;
(e) 4,4′-methylene dicyclohexyl diisocyanate (H12MDI);
(f) trimethyl hexamethylene diisocyanate (TMDI);
(g) 1,4-cyclohexyl diisocyanate (CHDI);
(h) tetramethyl xylene diisocyanate (TMXDI); and
(i) any mixture of two or more selected from (a)-(h).

Furthermore, the object of the present invention is a composition comprising said polymer and one or more technological additives.

Said composition is preferably in liquid form. More preferably, said composition is a solution, a dispersion or an emulsion.

Said one or more technological additives being selected from the following group:
(i) one or more polymers configured to obtain compositions with a wet effect, with greater abrasion resistance, and/or with better adhesion on a substrate, and/or to obtain flame retardant, and/or antibacterial, and/or film-forming properties; and/or
(ii) a further polymer which may be silicone such as alkyl polysiloxane (CAS No. 200074-76-6); or a paraffin with melting point comprised from 40° C. to 100° C., preferably comprised from 50° C. to 70° C. (e.g. available from the Supplier Iberceras), or a blocked isocyanate; and/or
(iii) nanoparticles of oxides of silica and/or cerium, titania, alumina, zirconia, or combinations thereof; and/or
(iv) any combination of (i)-(iii).

In this description, the term “blocked isocyanate” means mono-, di- and poly-isocyanates in which an isocyanate group has been reacted with blocking agents which, on heating, release the isocyanate and the blocking agent. Suitable blocking agents are known in the art, such as amines, amides, compounds with an active hydrogen atom or alcohols. If the heating takes place in the presence of a compound with a functional group capable of reacting with the isocyanate group, such as a hydroxyl group or an amine group of a suitable substrate such as a fibre, better adhesion can be obtained. Consequently, the blocked isocyanates, in particular the blocked polyisocyanates, present in preferred embodiments of the invention can confer increased adhesion to substrates having groups such as amino or hydroxyl groups that can react with said blocked isocyanate. Such blocked isocyanates are commercially available e.g. as Arkophob DAN, Arkophob SR and Cassurit FF (all from Archroma); Phobol XAN (Huntsman) and Ruco-Guard WEB (Rudolf).

In this description, the term “nanoparticles” means particles having an average particle size distribution comprised from 1 nm to 100 nm (this distribution being preferably determined by dynamic laser light scattering).

For embodiment (iii), the nanoparticles could optionally be surface functionalised in order to make them more compatible in the composition to which they are to be added. The combined action of the polymer subject-matter of the present invention (alone or in combination with the alkyl polysiloxane or the paraffin (ii)), which modifies the chemical composition of the surface, and of the nanoparticles, which modifies the geometric structure thereof creating a surface nano-roughness, greatly increases the water-phobicity and the oil-phobicity of a surface. Such a surface will have characteristics—by way of example—self-cleaning, anti-ice, and/or anti-biofouling. In addition, some types of nanoparticles are able to limit the degradation of the surface and of the organic molecules deposited, caused by the action of the sun's UV rays.

Furthermore, the object of the present invention is a use of said polymer or of said composition as a water-repellent and/or oil-repellent agent, and/or as an anti-stain agent, and/or as an anti-graffiti agent, of a substrate.

Said substrate is preferably selected from the group consisting of: paper, cardboard, natural fabrics, synthetic fabrics, carpet (i.e. rugs or carpet, preferably carpet), leather, eco-leather, leather and construction materials; preferably said construction materials being any one from among bricks, tiles, natural stone, reconstituted stone, ceramics, plasters, concretes, cements, mortars, wood, glass, metals and plastics.

Preferably, in said use, the polymer or the composition can be applied after dilution in a suitable solvent and allowed to dry. Application can take place by dipping, spraying, roller, sponge and/or brush. Drying can take place at room temperature or by heating.

The present invention will now be illustrated on the basis of the examples, provided purely by way of non-limiting example.

### EXAMPLES

### Example 1 (Reference) (LAB 140721)

In a 250 ml 4-neck flask equipped with a mechanical stirrer, thermometer, drop condenser, installed on a thermoregulated oil bath, the following are charged:

TABLE 2

| Monomer | Component | weight (g) | moles |
|---|---|---|---|
| (B.II) | Monomethacryloxypropyl | 15.18 | 0.0101 |
| | terminated polydimethylsiloxane | | |
| | (PDMS) | | |
| (C)³ | 2-hydroxypropyl methacrylate | 2.08 | 0.0146 |
| (D)¹ | tridecyl methacrylate | 3.02 | 0.0113 |
| (D)² | stearyl methacrylate | 2.87 | 0.0085 |
| (E)¹ | 2-dimethylamino ethyl methacrylate | 1.28 | 0.0084 |
| | butyl acetate (solvent) | 23.5 | // |
| | 2′,2′-azobis(isobutyronitrile) | 0.170 | 0.0010 |
| | (AIBN; catalyst) | | |

The reaction mixture is heated to a temperature of 80° C. under nitrogen atmosphere. The reaction is allowed to proceed for about 3 hours and then a second portion of AIBN equal to 0.17 g (0.00104 moles) is added.

The progress of the reaction with the reduction of the characteristic peak of the methacrylic 5 groups to about 1638 cm-1 is verified by IR analysis.

After about another 2 hours of reaction from the addition of the second portion of AIBN (0.170 g; 0.0010 mol), an IR analysis is performed to verify the disappearance of the characteristic peak of the methacrylic groups. The heating is then switched off, cooled to 60° C. and then about 50 g of butyl acetate is added to bring the titre of the solution to 25%.

In Example 1, only (B) is present.

### Example 2 (Reference) (LAB 310522)

It is proceeded as in Example 1, by charging the following substances into the flask in the amounts indicated.

TABLE 3

| Monomer | Component | weight (g) | moles |
|---|---|---|---|
| (B.I) | 3-[tris(trimethylsiloxy)silyl]propyl | 15.13 | 0.0358 |
| | methacrylate | | |
| (C)³ | 2-hydroxypropyl methacrylate | 2.04 | 0.0143 |
| (D)¹ | tridecyl methacrylate | 2.96 | 0.011 |
| (D)² | stearyl methacrylate | 2.87 | 0.0085 |
| (E)¹ | 2-dimethylamino ethyl methacrylate | 1.23 | 0.0078 |
| | butyl acetate (solvent) | 23.5 | // |
| | AIBN (catalyst) | 0.180 | 0.0011 |
| | AIBN (second portion) | 0.10 | 0.00061 |

In Example 2, (A) is absent.

### Example 3 (LAB 130721)

It is proceeded as in Example 1, by charging the following substances into the flask in the amounts indicated.

TABLE 4

| Monomer | Component | weight (g) | moles |
|---|---|---|---|
| (A.I) | (3-methacryloxy-2- | 15.00 | 0.036 |
| | hydroxypropoxy)propylbis(trimethylsiloxy) | | |
| | methylsilane | | |
| (C)³ | 2-hydroxypropyl methacrylate | 2.0 | 0.014 |
| (D)¹ | tridecyl methacrylate | 2.93 | 0.011 |
| (D)² | stearyl methacrylate | 2.87 | 0.0085 |
| (E)¹ | 2-dimethylamino ethyl methacrylate | 1.27 | 0.0077 |
| | butyl acetate (solvent) | 23.7 | // |
| | AIBN (catalyst) | 0.180 | 0.0011 |
| | AIBN (second portion) | 0.14 | 0.00085 |

### Example 4-1 (T1A-T16A)

It is proceeded as in Example 1, by charging the following substances into the flask in the amounts indicated (sample TIA).

TABLE 5

| Monomer | Component | weight (g) | moles |
|---|---|---|---|
| (A.I) | (3-methacryloxy-2- | 16.05 | 0.038 |
| | hydroxypropoxy)propylbis(trimethylsiloxy) | | |
| | methylsilane | | |
| (B.I) | 3-[tris(trimethylsiloxy)silyl]propyl | 5.02 | 0.012 |
| | methacrylate | | |
| (C)³ | 2-hydroxypropyl methacrylate | 4.04 | 0.028 |
| (D)² | stearyl methacrylate | 5.81 | 0.017 |
| (E)¹ | 2-dimethylamino ethyl methacrylate | 2.09 | 0.013 |
| | butyl acetate (solvent) | 32.04 | // |
| | AIBN (catalyst) | 0.15 | 0.00091 |
| | AIBN (second portion) | 0.14 | 0.00085 |

The synthesis is repeated as in Example 1 using the quantities (expressed in grams) indicated in the following Table 6:

TABLE 6

Monomer

| Sample | (A.I) | (B.I) | (C) | (D)² | (E)¹ |
|---|---|---|---|---|---|
| T2A | 19 | 2 | 4 | 3 | 3.6 |
| T3A | 16 | 2 | 2 | 5.8 | 2 |
| T4A | 19 | 2 | 2 | 5.8 | 3.6 |
| T5A | 19 | 2 | 4 | 5.8 | 2 |
| T6A | 16 | 2 | 4 | 5.8 | 3.6 |
| T7A | 19 | 2 | 2 | 3 | 2 |
| T8A | 16 | 2 | 2 | 3 | 3.6 |
| T9A | 19 | 5 | 4 | 5.8 | 3.6 |
| T10A | 16 | 2 | 4 | 3 | 2 |
| T11A | 19 | 5 | 4 | 3 | 2 |
| T12A | 19 | 5 | 2 | 3 | 3.6 |
| T13A | 16 | 5 | 4 | 3 | 3.6 |
| T14A | 16 | 5 | 2 | 3 | 2 |
| T15A | 19 | 5 | 2 | 5.8 | 2 |
| T16A | 16 | 5 | 2 | 5.8 | 3.6 |

### Example 4-2 (LAB 250722A)

It is proceeded as in Example 1, by charging the following substances into the flask in the amounts indicated.

TABLE 7

| Mono- | | weight | |
|---|---|---|---|
| mer | Component | (g) | moles |
| (A.I) | (3-methacryloxy-2- | 18.9 | 0.045 |
| | hydroxypropoxy)propylbis(trimethylsiloxy) | | |
| | methylsilane | | |
| (C)³ | 2-hydroxypropyl methacrylate | 2.01 | 0.014 |
| (D)¹ | tridecyl methacrylate | 1.01 | 0.0038 |
| (D)² | stearyl methacrylate | 1.07 | 0.0032 |
| (E)¹ | 2-dimethylamino ethyl methacrylate | 1.28 | 0.0081 |
| | butyl acetate (solvent) | 23.7 | // |
| | AIBN (catalyst) | 0.13 | 0.00079 |
| | AIBN (second portion) | 0.12 | 0.00073 |

### Example 4-2.A (LAB 290124)

It is proceeded as in Example 1, by charging the following substances into the flask in the amounts indicated.

TABLE 7.A

| Mono- | | weight | |
|---|---|---|---|
| mer | Component | (g) | moles |
| (A.I) | (3-methacryloxy-2- | 15.0 | 0.0355 |
| | hydroxypropoxy)propylbis(trimethylsiloxy) | | |
| | methylsilane | | |
| (C)³ | 2-hydroxypropyl methacrylate | 2.00 | 0.0141 |
| (D)² | stearyl methacrylate | 2.00 | 0.0059 |
| (D)³ | t-butyl methacrylate | 2.40 | 0.0169 |
| (E)¹ | 2-dimethylamino ethyl methacrylate | 2.60 | 0.0165 |
| | butyl acetate (solvent) | 23.5 | // |
| | AIBN (catalyst) | 0.14 | 0.00085 |
| | AIBN (second portion) | 0.11 | 0.00067 |

### Example 4-2.B (LAB 200324)

It is proceeded as in Example 1, by charging the following substances into the flask in the amounts indicated and allowing the reaction to proceed for about 4 hours and then adding the second portion of AIBN.

TABLE 7.B

| Mono- | | weight | |
|---|---|---|---|
| mer | Component | (g) | moles |
| (A.I) | (3-methacryloxy-2- | 25.0 | 0.0591 |
| | hydroxypropoxy)propylbis(trimethylsiloxy) | | |
| | methylsilane | | |
| (D)² | stearyl methacrylate | 2.00 | 0.0059 |
| (E)¹ | 2-dimethylamino ethyl methacrylate | 3.60 | 0.0229 |
| | butyl acetate (solvent) | 30.0 | // |
| | AIBN (catalyst) | 0.14 | 0.00085 |
| | AIBN (second portion) | 0.14 | 0.00085 |

### Example 4-2.C (LAB 210324)

It is proceeded as in Example 1, by charging the following substances into the flask in the amounts indicated and allowing the reaction to proceed for about 4 hours and then adding the second portion of AIBN.

TABLE 7.C

| Mono- | | weight | |
|---|---|---|---|
| mer | Component | (g) | moles |
| (A.I) | (3-methacryloxy-2- | 19.0 | 0.045 |
| | hydroxypropoxy)propylbis(trimethylsiloxy) | | |
| | methylsilane | | |
| (B.I) | 3-[tris(trimethylsiloxy)silyl]propyl | 5.00 | 0.0118 |
| | methacrylate | | |
| (D)² | stearyl methacrylate | 2.00 | 0.0059 |
| (E)¹ | 2-dimethylamino ethyl methacrylate | 3.60 | 0.0229 |
| | butyl acetate (solvent) | 29.0 | |
| | AIBN (catalyst) | 0.13 | 0.00079 |
| | AIBN (second portion) | 0.13 | 0.00079 |

### Example 4-3 (LAB 270722)

It is proceeded as in Example 1, by charging the following substances into the flask in the amounts indicated.

TABLE 8

| Mono- | | weight | |
|---|---|---|---|
| mer | Component | (g) | moles |
| (A.I) | (3-methacryloxy-2- | 15.2 | 0.036 |
| | hydroxypropoxy)propylbis(trimethylsiloxy) | | |
| | methylsilane | | |
| (B.I) | 3-[tris(trimethylsiloxy)silyl]propyl | 4.95 | 0.0012 |
| | methacrylate | | |
| (C)³ | 2-hydroxypropyl methacrylate | 0.98 | 0.0068 |
| (D)¹ | tridecyl methacrylate | 0.98 | 0.0037 |
| (D)² | stearyl methacrylate | 1.04 | 0.0031 |
| (E)¹ | 2-dimethylamino ethyl methacrylate | 1.24 | 0.0079 |
| | butyl acetate (solvent) | 23.5 | // |
| | AIBN (catalyst) | 0.12 | 0.00073 |
| | AIBN (second portion) | 0.11 | 0.00067 |

### Example 4-4 (LAB 280722)

It is proceeded as in Example 1, by charging the following substances into the flask in the amounts indicated.

TABLE 9.A

| Mono- | | weight | |
|---|---|---|---|
| mer | Component | (g) | moles |
| (A.I) | (3-methacryloxy-2- | 15.02 | 0.0355 |
| | hydroxypropoxy)propylbis(trimethylsiloxy) | | |
| | methylsilane | | |
| (B.II) | Monomethacryloxypropyl terminated | 4.77 | 0.0032 |
| | polydimethylsiloxane (PDMS) | | |
| (C)³ | 2-hydroxypropyl methacrylate | 1.0 | 0.0069 |
| (D)¹ | tridecyl methacrylate | 1.02 | 0.0038 |
| (D)² | stearyl methacrylate | 1.04 | 0.0031 |
| (E)¹ | 2-dimethylamino ethyl methacrylate | 1.23 | 0.0078 |
| | butyl acetate (solvent) | 23.5 | // |
| | AIBN (catalyst) | 0.09 | 0.00055 |
| | AIBN (second portion) | 0.12 | 0.00073 |

### Example 4-5 (LAB 130721A)

It is proceeded as in Example 1, by charging the following substances into the flask in the amounts indicated.

TABLE 9.B

| Mono- | | weight | |
|---|---|---|---|
| mer | Component | (g) | moles |
| (A.II) | (A.II) wherein R3 is methyl | 14.98 | |
| (C)³ | 2-hydroxypropyl methacrylate | 1.0 | 0.0069 |
| (D)¹ | tridecyl methacrylate | 1.02 | 0.0038 |
| (D)² | stearyl methacrylate | 1.04 | 0.0031 |
| (E)¹ | 2-dimethylamino ethyl methacrylate | 1.23 | 0.0078 |
| | butyl acetate (solvent) | 23.5 | // |
| | AIBN (catalyst) | 0.09 | 0.00055 |
| | AIBN (second portion) | 0.12 | 0.00073 |

### Example 5 (LAB 141022)

It is proceeded as in Example 1, by charging the following substances into the flask in the amounts indicated.

TABLE 10

| Mono- | | weight | |
|---|---|---|---|
| mer | Component | (g) | moles |
| (A.I) | (3-methacryloxy-2- | 19.03 | 0.045 |
| | hydroxypropoxy)propylbis(trimethylsiloxy) | | |
| | methylsilane | | |
| (B.I) | 3-[tris(trimethylsiloxy)silyl]propyl | 2.02 | 0.0048 |
| | methacrylate | | |
| (C)² | methacrylic acid | 0.27 | 0.0031 |
| (E)¹ | 2-dimethylamino ethyl methacrylate | 4.1 | 0.022 |
| | isopropyl alcohol (IPA; solvent) | 28.0 | // |
| | AIBN (catalyst) | 0.14 | 0.00085 |
| | AIBN (second portion) | 0.14 | 0.00085 |

After about 2 hours from the addition of the second AIBN portion, an IR analysis is performed to verify the disappearance of the characteristic peak of the methacrylic groups. The heating is then switched off, cooled to 60° C. and then 1.1 g (0.0183 mol) of glacial acetic acid and a 0.6 g solution of 35% hydrogen peroxide in 70.4 g demineralized water are added. It is heated to 80° C. and allowed to stir for 2 hours. The IPA is removed under nitrogen flow at 80° C. over about 3 hours.

Finally, 30.6 g of demineralized water are added to bring the product titre to 25%.

### Example 6 (LAB 181022)

It is proceeded as in Example 1, by charging the following substances into the flask in the amounts indicated.

TABLE 11

| Mono- | | weight | |
|---|---|---|---|
| mer | Component | (g) | moles |
| (A.I) | (3-methacryloxy-2- | 14.11 | 0.0334 |
| | hydroxypropoxy)propylbis(trimethylsiloxy) | | |
| | methylsilane | | |
| (B.I) | 3-[tris(trimethylsiloxy)silyl]propyl | 1.49 | 0.0035 |
| | methacrylate | | |
| (C)¹ | 2-carboxyethyl acrylate | 2.30 | 0.0160 |
| (C)² | methacrylic acid | 0.37 | 0.0043 |
| (D)⁴ | isobutyl acrylate | 1.95 | 0.0152 |
| (F) | N-vinyl pyrrolidinone | 2.57 | 0.0231 |
| | tert-butanol (solvent) | 25.0 | // |
| | AIBN (catalyst) | 0.30 | 0.0018 |
| | AIBN (second portion) | 0.21 | 0.0013 |

After about 2 hours from the addition of the second AIBN portion, an IR analysis is performed to verify the disappearance of the characteristic peak of the (meth)acrylic groups. The heating is then switched off, cooled to 60° C. and then 1.64 g (0.0184 mol) of 2-amino-2-methyl-1-propanol are added and stirred for at least 15 minutes.

Finally, 50.0 g of demineralized water are added to bring the product titre to 25%.

### Example 7 (LAB 191022)

It is proceeded as in Example 1, by charging the following substances into the flask in the amounts indicated.

TABLE 12

| Mono- | | weight | |
|---|---|---|---|
| mer | Component | (g) | moles |
| (A.I) | (3-methacryloxy-2- | 10.9 | 0.026 |
| | hydroxypropoxy)propylbis(trimethylsiloxy) | | |
| | methylsilane | | |
| (B.I) | 3-[tris(trimethylsiloxy)silyl]propyl | 1.14 | 0.0027 |
| | methacrylate | | |
| (C)¹ | 2-carboxyethyl acrylate | 0.46 | 0.0032 |
| (C)² | methacrylic acid | 1.3 | 0.015 |
| (E)³ | 2-diethylamino ethyl methacrylate | 2.3 | 0.012 |
| | isopropyl alcohol (IPA; solvent) | 15 | // |
| | AIBN (catalyst) | 0.1 | 0.00061 |
| | AIBN (second portion) | 0.1 | 0.00061 |

After about 2 hours from the addition of the second AIBN portion, an IR analysis is performed to verify the disappearance of the characteristic peak of the (meth)acrylic groups. The heating is then switched off, cooled to 60° C. and then the 65° C. heated solution of 0.685 g (0.017moi) of sodium hydroxide in 67.93 g of demineralized water is added. The solution is 5 stirred for 30 minutes.

The IPA is removed under nitrogen flow at 80° C. under vacuum over about 3 hours.

The following Table 13 summarizes in synthetic form the compositions of the polymers obtained in accordance with the previous examples.

TABLE 13
Solvent: butyl acetate

| Sample | Monomer/weight in grams (rounded, no decimals) | | | | | |
|---|---|---|---|---|---|---|
| LAB | // | (B.II)/ | (C)³/ | (D)¹/ | (D)²/ | (E)¹/ |
| 140721 | | 15 g | 2 g | 3 g | 3 g | 1 g |
| LAB | // | (B.I)/ | (C)³/ | (D)¹/ | (D)²/ | (E)¹/ |
| 310522 | | 15 g | 2 g | 3 g | 3 g | 1 g |
| LAB | (A.I)/ | // | (C)³/ | (D)¹/ | (D)²/ | (E)¹/ |
| 130721 | 15 g | | 2 g | 3 g | 3 g | 1 g |
| LAB | (A.II)/ | // | (C)³/ | (D)¹/ | (D)²/ | (E)¹/ |
| 130721A | 15 g | | 2 g | 3 g | 3 g | 1 g |
| LAB | (A.I)/ | // | (C)³/ | (D)¹/ | (D)²/ | (E)¹/ |
| 250722A | 19 g | | 2 g | 1 g | 1 g | 1 g |
| LAB | (A.I)/ | // | (C)³/ | (D)²/ | (D)³/ | (E)¹/ |
| 290124 | 15 g | | 2 g | 2 g | 2 g | 3 g |
| LAB | (A.I)/ | // | // | (D)²/ | // | (E)¹/ |
| 200324 | 25 g | | | 2 g | | 4 g |
| LAB | (A.I)/ | (B.I)/ | // | (D)²/ | // | (E)¹/ |
| 210324 | 19 g | 5 g | | 2 g | | 4 g |
| LAB | (A.I)/ | (B.II)/ | (C)³/ | (D)¹/ | (D)²/ | (E)¹/ |
| 280722 | 15 g | 5 g | 1 g | 1 g | 1 g | 1g |
| T1A | (A.I)/ | (B.I)/ | (C)³/ | // | (D)²/ | (E)¹/ |
| | 16 g | 5 g | 4 g | | 6 g | 2 g |
| T2A | (A.I)/ | (B.I)/ | (C)³/ | // | (D)²/ | (E)¹/ |
| | 19 g | 2 g | 4 g | | 3 g | 4 g |
| T3A | (A.I)/ | (B.I)/ | (C)³/ | // | (D)²/ | (E)¹/ |
| | 16 g | 2 g | 2 g | | 6 g | 2 g |
| T4A | (A.I)/ | (B.I)/ | (C)³/ | // | (D)²/ | (E)¹/ |
| | 19 g | 2 g | 2 g | | 6 g | 4 g |
| T5A | (A.I)/ | (B.I)/ | (C)³/ | // | (D)²/ | (E)¹/ |
| | 19 g | 2 g | 4 g | | 6 g | 2 g |
| T6A | (A.I)/ | (B.I)/ | (C)³/ | // | (D)²/ | (E)¹/ |
| | 16 g | 2 g | 4 g | | 6 g | 4 g |
| T7A | (A.I)/ | (B.I)/ | (C)³/ | // | (D)²/ | (E)¹/ |
| | 19 g | 2 g | 2 g | | 3 g | 2 g |
| T8A | (A.I)/ | (B.I)/ | (C)³/ | // | (D)²/ | (E)¹/ |
| | 16 g | 2 g | 2 g | | 3 g | 4 g |
| T9A | (A.I)/ | (B.I)/ | (C)³/ | // | (D)²/ | (E)¹/ |
| | 19 g | 5 g | 4 g | | 6 g | 4 g |
| T10A | (A.I)/ | (B.I)/ | (C)³/ | // | (D)²/ | (E)¹/ |
| | 16 g | 2 g | 4 g | | 3 g | 2 g |
| T11A | (A.I)/ | (B.I)/ | (C)³/ | // | (D)²/ | (E)¹/ |
| | 19 g | 5 g | 4 g | | 3 g | 2 g |
| T12A | (A.I)/ | (B.I)/ | (C)³/ | // | (D)²/ | (E)¹/ |
| | 19 g | 5 g | 2 g | | 3 g | 4 g |
| T13A | (A.I)/ | (B.I)/ | (C)³/ | // | (D)²/ | (E)¹/ |
| | 16 g | 5 g | 4 g | | 3 g | 4 g |
| T14A | (A.I)/ | (B.I)/ | (C)³/ | // | (D)²/ | (E)¹/ |
| | 16 g | 5 g | 2 g | | 3 g | 2 g |
| T15A | (A.I)/ | (B.I)/ | (C)³/ | // | (D)²/ | (E)¹/ |
| | 19 g | 5 g | 2 g | | 6 g | 2 g |
| T16A | (A.I)/ | (B.I)/ | (C)³/ | // | (D)²/ | (E)¹/ |
| | 16 g | 5 g | 2 g | | 6 g | 4 g |
| LAB | (A.I)/ | (B.I)/ | (C)³/ | (D)¹/ | (D)²/ | (E)¹/ |
| 270722 | 15 g | 5 g | 1 g | 1 g | 1 g | 1 g |

Solvent: water

| | | | | | | |
|---|---|---|---|---|---|---|
| LAB | (A.I)/ | (B.I)/ | | (C)²/ | // | (E)¹/ |
| 141022 | 19 g | 2 g | | <1 g | | 4 g |
| LAB | (A.I)/ | (B.I)/ | (C)¹/ | (C)²/ | (D)⁴/ | (F)/ |
| 181022 | 14 g | 2 g | 2 g | <1 g | 2 g | 3 g |
| LAB | (A.I)/ | (B.I)/ | (C)¹/ | (C)²/ | (E)³/ | // |
| 191022 | 11 g | 1 g | <1 g | 1 g | 2 g | |

In this regard, it should be noted that the quotes placed at the monomers in Table 13 above identify the types of monomer used in each of the previous samples and indicated in the respective Tables from 1 to 12 with the same quote (for example: (D)²=stearyl methacrylate; (C)²=methacrylic acid; (E)¹=2-dimethylamino ethyl methacrylate).

### Example 6: Evaluation of the Anti-Stain Effect on Stone

The products in 25% solution obtained by the previous examples are diluted in butyl acetate or with water (Example 5 only) at the concentrations of 2.5%, 5% and 10%.

The solutions are applied by sponge on serene stone, Vicenza stone and white Carrara marble. Before application, the Vicenza stone and white Carrara marble are cleaned with hot running water while the serene stone is subjected to acid washing by means of a 1:4 solution of perchloric acid in water and subsequently rinsed under running water; the washed stones are allowed to dry before application.

After application of the products, it is waited for 24 hours and then a drop of water, one of oil and one of coffee are deposited on the treated surfaces. After 8 hours the drops are removed and the anti-stain effects are evaluated.

The following table shows the results of contact angle tests obtained on the stones treated with 2.5% solutions of polymer in butyl acetate. The contact angle was evaluated against water and hexadecane after 20 seconds. The values indicated in Table 14 are average values on five measurements made. The abbreviation “a.m.” means “active substance” (active material).

TABLE 14

| | | | |
|---|---|---|---|
| | Active ingredient | angle against | angle against |
| Sample | concentration | water | hexadecane |

Solvent: butyl acetate

| | | | |
|---|---|---|---|
| LAB 140721 | 2.5% a.m. | 104° | <10° |
| LAB 310522 | 2.5% a.m. | 105° | <10° |
| LAB 130721 | 2.5% a.m. | 126.8° | 24.7° |
| LAB 130721 | 5.0% a.m. | 120.2° | 37.9° |
| LAB 130721 | 10% a.m. | 111.1° | 32.2° |
| LAB 130721A | 2.5% a.m. | 128.2° | 26.1° |
| LAB 130721A | 5.0% a.m. | 122.1° | 38.7° |
| LAB 130721A | 10% a.m. | 113.2° | 33.8° |
| LAB 250722A | 2.5% a.m. | 125.5° | 42.7° |
| LAB 290124 | 2.5% a.m. | 132.23° | 44.03° |
| LAB 200324 | 2.5% a.m. | 134.36° | 47.08° |
| LAB 210324 | 2.5% a.m. | 135.82° | 46.75° |
| LAB 280722 | 2.5% a.m. | 128° | 43.4° |
| T1A | 2.5% a.m. | 131.14° | 45.47° |
| T2A | 2.5% a.m. | 126.34° | 44.40° |
| T3A | 2.5% a.m. | 131.37° | 47.78° |
| T4A | 2.5% a.m. | 129.69° | 44.37° |
| T5A | 2.5% a.m. | 129.00° | 45.43° |
| T6A | 2.5% a.m. | 132.05° | 43.04° |
| T7A | 2.5% a.m. | 124.10° | 47.44° |
| T8A | 2.5% a.m. | 127.16° | 44.38° |
| T9A | 2.5% a.m. | 129.68° | 48.66° |
| T10A | 2.5% a.m. | 131.82° | 48.30° |
| T11A | 2.5% a.m. | 130.71° | 46.57° |
| T12A | 2.5% a.m. | 134.35° | 46.97° |
| T13A | 2.5% a.m. | 130.85° | 48.71° |
| T14A | 2.5% a.m. | 135.42° | 56.03° |
| T15A | 2.5% a.m. | 129.94° | 48.88° |
| T16A | 2.5% a.m. | 133.04° | 43.39° |
| LAB 270722 | 2.5% a.m. | 127.4° | 48.9° |

Solvent: water

| | | | |
|---|---|---|---|
| LAB 141022 | 2.5% a.m. | 118.50° | 48.57° |
| LAB 181022 | 2.5% a.m. | 119.24° | 48.18° |
| LAB 191022 | 2.5% a.m. | 119.41° | 48.46° |

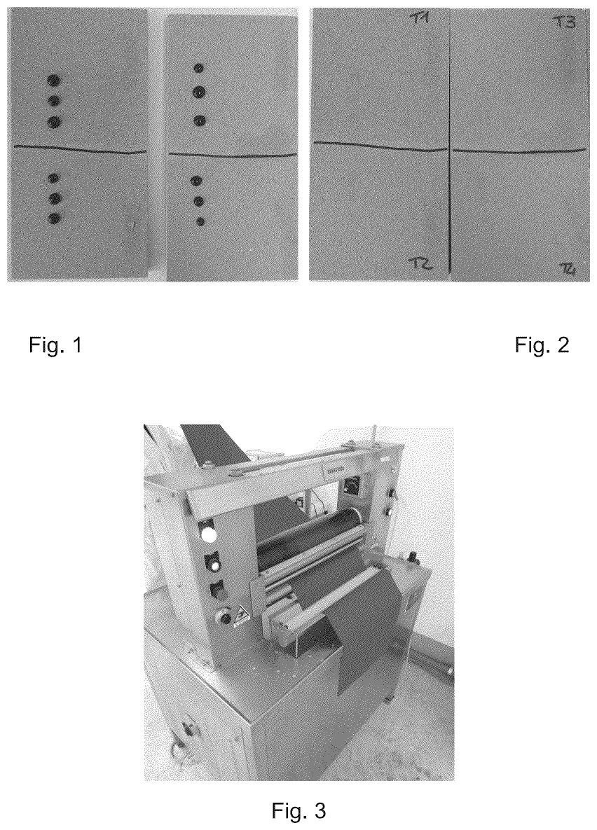

The enclosed FIG. 1 reports the samples to which three drops of coffee were applied for samples T1A (upper left quadrant), T2A (lower left quadrant), T3A (upper right quadrant), T4A (lower right quadrant). FIG. 2 shows the effectiveness of the anti-stain effect after the removal of the drops, where the arrangement of the quadrants is unchanged with respect to FIG. 1.

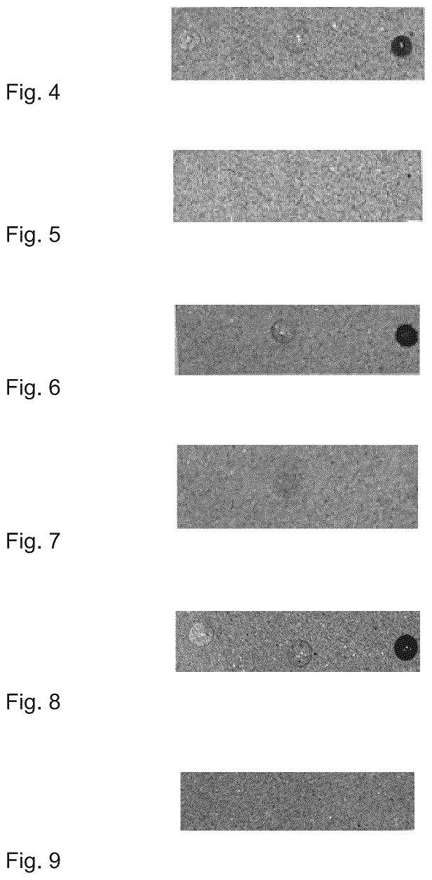

The enclosed FIG. 4 and FIG. 5 report samples of serene stone treated with LAB 290124 to which a drop of water, a drop of oil and a drop of coffee were applied just after application (FIG. 4) and after 24 hours from the removal of the drops (FIG. 5) previously left on the stone for 5 hours.

The enclosed FIG. 6 and FIG. 7 report samples of serene stone treated with LAB 200324 to which a drop of water, a drop of oil and a drop of coffee were applied just after application (FIG. 6) and immediately after removal of the drops (FIG. 7) previously left on the stone for 5 hours.

The enclosed FIG. 8 and FIG. 9 report samples of serene stone treated with LAB 210324 to which a drop of water, a drop of oil and a drop of coffee were applied just after application (FIG. 8) and immediately after removal of the drops (FIG. 9) previously left on the stone for 5 hours.

### Conclusions Related to the Contact Angle Tests:

All polymers subject-matter of the present invention (even those applied on samples not shown in the figures) have been shown to possess good, or even excellent, repellency features on the three stones tested. The best samples in this test were T3A, T5A, T9A, and T12A.

From the tests relating to the LAB 130721 and LAB 130721A samples-in which only the compound (A.I) or only the compound (A.II) is present but not the compound (B)-results can be obtained that approach the tests carried out with the TIA-T16A samples as long as the concentration value is increased. A concentration value comprised from 4.0% a.m. to 6.0% a.m. is considered advantageous in these tests, as for the tests carried at 10% a.m. no increase in the contact angles was found.

Also for the tests relating to the LAB 280722 sample-in which, in addition to (A) there is also polydimethylsiloxane terminated with monomethacryloxypropyl (B.II)-acceptable contact angles were obtained. As can be seen in Table 14 reported above, in the presence of a percentage of 2.5% of active substance, the angle with hexadecane for the LAB 130721 test was 24.7°, and for the LAB 130721A test it was 26.1°. If the same test is performed using the monomers terminated with monomethacryloxypropyl (B.II) or (B.I)—respectively LAB 140721 and LAB 310522 test—the angles did not exceed 10°.

The comparison of the tests LAB 130721 with LAB 270722 and LAB 280722 shows an improvement in the angle with hexadecane (better oil-repellency) with the introduction of a second silicone monomer such as polydimethylsiloxane terminated with monomethacryloxypropyl (B.II) or 3-[tris(trimethylsiloxy) silyl]propyl methacrylate (B.I). The angle is better (48.9°) using (B.I).

With regard to the LAB 290124 sample, a very good anti-stain effect emerges, although the contact angle with hexadecane was not among the best of the tests.

In relation to the LAB 200324 and LAB 210324 samples, excellent contact angles with water and hexadecane emerge. For LAB 200324 an anti-stain effect with margin for improvement is reported, but for the LAB 210324 sample there are no evident stains.

### Example 7: Evaluation of Anti-Stain Effect on Fabrics

The products as per samples T3A, T5A, T9A, T12A and T14A are diluted with butyl acetate in concentration at 2% by weight.

In addition, the products as per samples T5A and LAB 290124 are diluted with butyl acetate in concentration at 2.5% by weight.

With the solutions as per samples T3A, T5A (2%), T9A, T12A and T14A they are a cotton fabric, a polyamide fabric, a suede leather and an eco-leather using a low pressure spray application.

With the solutions as per samples T5A (2.5%) and LAB 290124 they are brown suede leather, orange nubuck leather and light blue nubuck leather.

After 24 hours of drying at room temperature, visual and tactile appearance, water-repellency and oil-repellency were evaluated according to AATCC 193 (aqueous liquid repellency) and AATCC 118-2002 (hydrocarbon resistance) standards. These standards are valid on the filing or priority date of this application.

The results relative to the samples T3A, T5A (2%), T9A, T12A and T14A are shown in Tables from 15 to 18.

The results relative to the samples T5A (2.5%) and LAB 290124 are shown in Tables from 18.A to 18.D.

TABLE 15

| Cotton | AATCC 193 |
|---|---|
| T3A | 5 |
| T5A | 5 |
| T9A | 5 |
| T12A | 5 |
| T14A | 5 |

TABLE 16

| Polyamide | AATCC 193 |
|---|---|
| T3A | 5 |
| T5A | 5 |
| T9A | 5 |
| T12A | 5 |
| T14A | 5 |

TABLE 17

| Suede leather | AATCC 193 |
|---|---|
| T3A | 2-3 |
| T5A | 3 |
| T9A | 2-3 |
| T12A | 2 |
| T14A | 2 |

TABLE 18

| Eco-leather | AATCC 193 |
|---|---|
| T3A | 4-5 |
| T5A | 5-6 |
| T9A | 4 |
| T12A | 4 |
| T14A | 3-5 |

All samples tested according to AATCC 193 standard gave satisfactory results.

With regard to the tests carried out according to AATCC 118-2002 standard, the samples 5 T5A (2%) and T9A were found to provide acceptable oil-repellency. The sample T5A (2.5%) provided one of the best oil-repellency of the test.

TABLE 18.A

| Brown suede leather | AATCC 193 |
|---|---|
| T5A (2.5%) | 5 |
| LAB 290124 | 5 |

TABLE 18.B

| Orange nubuck leather | AATCC 193 |
|---|---|
| T5A (2.5%) | 5 |
| LAB 290124 | 4 |

TABLE 18.C

| Light blue nubuck leather | AATCC 193 |
|---|---|
| T5A (2.5%) | 4 |
| LAB 290124 | 4 |

TABLE 18.D

| | AATCC |
|---|---|
| T5A (2.5%) | 118-2002 |
| Brown suede leather | 1 |
| Orange nubuck leather | 2 |
| Light blue nubuck leather | 1 |

The results of the following Table 19 relate to tests carried out on stone with LAB 130721 samples:

TABLE 19

| | Active ingredient | AATCC |
|---|---|---|
| Sample | concentration | 118-2002 |
| LAB 130721 | 2.5% a.m. | 2 |
| LAB 130721 | 5.0% a.m. | 2 |
| LAB 130721 | 10% a.m. | 2 |
| LAB 250722A | 2.5% a.m. | ⅔ |
| LAB 280722 | 2.5% a.m. | ⅔ |
| T14A | 2.5% | ¾ |

Also the LAB 130721 samples (regardless of all concentrations), LAB 250722A, LAB 270722 and LAB 280722 provided acceptable oil-repellency. With the sample T14A, an oil-repellency of 3/4 was achieved. LAB 130721A gave results in line with the LAB 130721 sample.

### Example 8: Textile Treatment-Synthesis of the Polymers 1-3

The formulations defined above were extrapolated for polymerization in emulsion for textile treatment.

Polymer 1: emulsion of polymer according to the invention prepared by emulsifying twice in a Manton-Gaulin apparatus (at 400 bar at 60° C.) a mixture formed by:

TABLE 20

| | | weight | |
|---|---|---|---|
| Monomer | Component | (g) | moles |
| (A.I) | (3-methacryloxy-2- | 60.7 | 0.144 |
| | hydroxypropoxy)propylbis(trimethylsiloxy) | | |
| | methylsilane | | |
| (B.I) | 3-[tris(trimethylsiloxy)silyl]propyl | 9.05 | 0.021 |
| | methacrylate | | |
| (C) | glycidyl methacrylate | 2.36 | 0.017 |
| (C) | 2-hydroxyethyl methacrylate | 2.9 | 0.022 |
| (D) | behenyl acrylate* | 32.2 | |
| | dodecanethiol (molecular weight regulator) | 0.41 | 0.002 |
| | dipropylene glycol (co-solvent) | 37.8 | |
| | C12 / C16 alcohol ethoxylated with 5-15 | 7.1 | |
| | units of ethylene oxide (surfactant) | | |
| | demineralized water (solvent) | 199.3 | // |

*e.g. available from Sigma Aldrich

The emulsion is charged into a 1000 ml 4-neck flask equipped with a mechanical stirrer, thermometer, drop condenser, nitrogen flow, mounted on a thermoregulated oil bath. After 30° C. has been reached, 11 g of 1,1-dichloroethene are added and then heated to 60° C. by adding-once an intermediate temperature of 40° C. has been reached—an aliquot of catalyst formed by 14 g of water and 1 g of 2,2-azobis(2-methylpropionamidine) dihydrochloride. After 2 hours of slow stirring at 60° C., a further aliquot of radical catalyst equal in composition and quantity to the first one is added. The polymerization time is 5 hours at 60° C. At the end of the reaction, the excess vinyl chloride is distilled under vacuum at 50° C. with 10 residual pressure of 100 m bar. The resulting dispersion has a solids content of about 30% by weight.

### Polymer 2:

It is proceeded as for Polymer 1 by charging into the flask a mixture formed by:

TABLE 21

| | | weight | |
|---|---|---|---|
| Monomer | Component | (g) | moles |
| (A.I) | (3-methacryloxy-2- | 47.9 | 0.113 |
| | hydroxypropoxy)propylbis(trimethylsiloxy) | | |
| | methylsilane | | |
| (B.I) | 3-[tris(trimethylsiloxy)silyl]propyl | 14.9 | 0.035 |
| | methacrylate | | |
| (C) | glycidyl methacrylate | 1.40 | 0.10 |
| (C) | 2-hydroxyethyl methacrylate | 0.71 | 0.005 |
| (D) | behenyl acrylate* | 20.9 | |
| | dodecanethiol (molecular weight regulator) | 0.31 | 0.002 |
| | dipropylene glycol (co-solvent) | 24.1 | |
| | C12 / C16 alcohol ethoxylated with 5-15 | 5.26 | |
| | units of ethylene oxide (surfactant) | | |
| | demineralized water (solvent) | 166.7 | // |

*e.g. available from Sigma Aldrich

The flask contains 193.9 g of a 55% wax emulsion (cationic emulsion, density at 25° C. 0.94 g/ml) in water with wax melting point 55-60° C. At 30° C. 9.4 g of 1,1-dichloroethene are added and heated to 60° C. to add—once an intermediate temperature of 40° C. has been reached—an aliquot of catalyst formed by 14 g of water and 1 g of 2,2′-azobis(2-methylpropionamidine) dihydrochloride. After 2 hours of slow stirring at 60° C., a further aliquot of radical catalyst equal in composition and quantity to the first one is added. The polymerization time is 5 hours at 60° C. At the end of the reaction, the excess vinyl chloride is distilled under vacuum at 50° C. with residual pressure of 100 mbar. The resulting dispersion 10 has a solids content of about 40% by weight.

### Polymer 3:

It is proceeded as for Polymer 1 by charging into the flask a mixture formed by:

TABLE 22

| Mono- | | weight | |
|---|---|---|---|
| mer | Component | (g) | moles |
| (A.I) | (3-methacryloxy-2- | 27.9 | 0.067 |
| | hydroxypropoxy)propylbis(trimethylsiloxy) | | |
| | methylsilane | | |
| (B.I) | 3-[tris(trimethylsiloxy)silyl]propyl | 9.10 | 0.022 |
| | methacrylate | | |
| (C) | glycidyl methacrylate | 0.54 | 0.0038 |
| (C) | 2-hydroxyethyl methacrylate | 0.30 | 0.0023 |
| (D) | behenyl acrylate* | 9.17 | |
| (D) | methyl methacrylate | 6.72 | 0.067 |
| | dodecanethiol (molecular weight regulator) | 0.10 | 0.0005 |
| | dipropylene glycol (co-solvent) | 14.6 | |
| | C12 / C16 alcohol ethoxylated with 5-15 | 4.44 | |
| | units of ethylene oxide (surfactant) | | |
| | demineralized water (solvent) | 101.5 | // |

*e.g. available from Sigma Aldrich

The emulsion is charged into a 1000 ml 4-neck flask equipped with a mechanical stirrer, thermometer, drop condenser, nitrogen flow, mounted on a thermoregulated oil bath. Once the temperature has stabilized at 30° C., 11 g of 1,1-dichloroethene are added. It is then heated to 60° C. and then added-once an intermediate temperature of 40° C. has been reached—an aliquot of catalyst formed by 10.3 g of water and 1 g of 2,2-azobis(2-methylpropionamidine) dihydrochloride. After 2 hours of slow stirring at 60° C., a further aliquot of radical catalyst equal in composition and quantity to the first one is added. The polymerization time is 5 hours at 60° C. At the end of the reaction, the excess vinyl chloride 10 is distilled under vacuum at 50° C. with residual pressure of 100 m bar. The resulting dispersion has a solids content of about 30% by weight.

### Example 9: Textile Treatment-Treatment of the Substrates

The treatment of the substrate was carried out by adopting the following procedure:
(I) Cut a piece of substrate (leather or fabric, for example cotton, polyester, polyamide, . . . ) with approximate dimensions of 60 cm×20 cm;
(II) Weigh the dry substrate on an analytical scale;
(III) Switch on the foulard instrument (FIG. 3; Model 20 FL 500, manufacturer Off. Elettromeccanica Gavazzi), by setting a pressure of the rollers at 3 bar and a rotation speed at 0.60 cm/minute;
(IV) Fit a bath for the wetting solution containing the protective agent on the front part of the foulard instrument, inserting the wetting solution (in a volume comprised from half a litre to 1 litre);
(V) Start the rollers of the foulard instrument, inserting the substrate between them after having been immersed in the bath of the wetting solution;
(VI) Slide the substrate out of the rollers, pick it up and re-introduce it between the two rollers for a second step (avoiding passing the substrate into the bath with the wetting solution); (VII) Weigh the wet substrate, so as to be able to evaluate the amount of wetting solution remained in the substrate (pick up of the substrate), according to the following formula:

$$Pick up = ( ( final substrate weight - initial substrate weight ) / initial substrate weight ) * 100$$

(VIII) Carry out the drying step (drying) by inserting the substrate in an oven at 120° C. for 1.5 minutes;
(IX) Carry out a crosslinking step (curing) by inserting the substrate in an oven at 150° C. for 3 minutes;
(X) Take the dry substrate and carry out the evaluation tests.

### Example 9: Textile Treatment—Assessment by AATCC Test

Drops of oils with different surface tensions are applied to a treated substrate. The drops are removed after 30 seconds and the absorption of the drop by the treated surface is evaluated. The oil-repellency grade is identified as the highest of the tested grades that is not completely absorbed within 30 seconds. The following Table 23 illustrates the grades of oil applied:

TABLE 23

| | | Surface |
|---|---|---|
| Test Number | | tension |
| Alkanes | Oil | (mN/m) |
| 1 | Refined mineral oil | 31.50 |
| 2 | Mineral oil/n-hexadecane | 29.20 |
| | (65/35) | |
| 3 | n-hexadecane | 27.30 |
| 4 | n-tetradecane | 26.20 |
| 5 | n-dodecane | 24.60 |
| 6 | n-decane | 23.60 |
| 7 | n-octane | 21.80 |
| 8 | n-heptane | 19.70 |

The following tables illustrate in schematic form the results of the tests carried out according to AATCC 118-2002 and contact angle with water (using the instrument Drop Shape AnalyZer-DSA100 tool).

TABLE 24

| | AATCC | Contact angle |
|---|---|---|
| Cotton | 118-2002 | with water |
| Polymer 1 | ½ | 127.6° |
| Polymer 2 | ½ | 137.6° |
| Polymer 3 | 1 | 139.0° |

TABLE 25

| | AATCC | Contact angle |
|---|---|---|
| Polyamide | 118-2002 | with water |
| Polymer 1 | 2 | 136.1° |
| Polymer 2 | 2 | 139.0° |
| Polymer 3 | 2 | 139.1 |

A discrete oil-repellency is confirmed in the textile treatment using formulations Polymer 1 in aqueous emulsion.

The water-repellency with Polymer 1 is good; contact angles with water were 127.6° and 136.1° for cotton and polyamide, respectively.

The water-repellency was improved by using, together with the selected monomers, a wax in aqueous emulsion (Polymer 2). The contact angles with water were 137.6° and 139.0° for cotton and polyamide, respectively. In Polymer 2 the water-repellency was improved even in the presence of a smaller amount of compound (A).

In Polymer 3, there is an improvement in water-repellency and oil-repellency without the use of an emulsified wax, increasing the weight percentage of the monomers (A.I) and (B.I) and introducing methyl methacrylate together with behenyl acrylate.

The invention has the following advantages.

Advantageously, the polymer and the composition subject-matter of the present invention have a reversibility of water-repellency and oil-repellency.

Advantageously, the interest in applying the polymer and the composition subject-matter of the present invention is due to its ability to exhibit low molecular cohesion energy, and consequently low surface energy properties such as to produce the lowering of the surface tension in aqueous or organic environments. By way of example, the surface tension values could be comprised from about 15 dyn/cm to about 30 dyn/cm, in particular comprised from 19 dyn/cm to about 25 dyn/cm.

Advantageously, the interest in applying the polymer and the composition subject-matter of the present invention is due to their ability to lower the surface tension to values comparable to the fluorinated acrylic polymers with similar structures.

In particular, the polymer and the composition subject-matter of the present invention were very interesting due to their ability to exhibit and confer high surface properties.

Advantageously, the polymer and the composition subject-matter of the present invention allow to obtain solutions of any titre, even of concentrations close to purity.

Regardless of this, the polymer and the composition subject-matter of the present invention are extremely performing even at low concentrations.

Advantageously, the polymer and the composition subject-matter of the present invention are “fluorine free”, which is why they represent a valid alternative to the fluorinated polymers, which instead are characterized by objective environmental problems.

Advantageously, the additional components described above allow to greatly increase the water-oil-phobic properties of the treated surfaces, which is why the described polymer and the composition are highly performing also in relation to these properties.

Advantageously, the polymer and the composition subject-matter of the present invention have a good adhesion to the surfaces to be treated.

Advantageously, the polymer and the composition subject-matter of the present invention has a good permeability to water vapour.

Advantageously, the polymer and the composition subject-matter of the present invention has a good chemical and physical compatibility with the substrates to be treated.

Advantageously, the polymer and the composition subject-matter of the present invention has a good chemical, physical, thermal and photo-oxidative stability.

Advantageously, the polymer and the composition subject-matter of the present invention has a good solubility of eco-compatible solvents.

Advantageously, the polymer and the composition subject-matter of the present invention did not generate any colour change of the substrates.

Although not previously specified, a person skilled in the art may envisage, resorting to the typical expertise of the sector, to vary or replace some of the aspects indicated above with other technically equivalent elements.

These variations or replacements also fall within the scope defined by the following claims.

Moreover, each alternative illustrated in relation to a particular embodiment may be embodied independently of the other variants described.

1. A polymer obtained by a polymerization between at least:
(A) or a combination of (A) and (B); and
at least two selected from (C), (D), (E), optionally (F), and combinations thereof;
wherein:
(A) is a compound of general formula (A.I) or (A.II), or a mixture of (A.I) and (A.II): 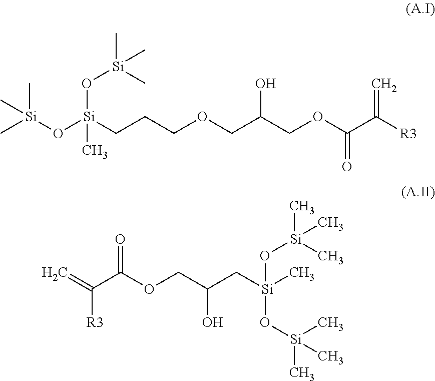
wherein R³ is independently hydrogen or methyl;
(B) is a compound of general formula (B.I) or (B.II), or a mixture of (B.I) and (B.II): 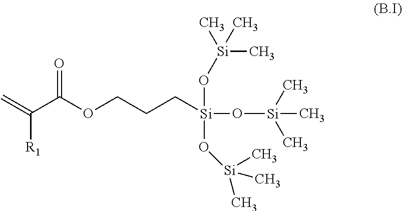
wherein R¹ is hydrogen or methyl; 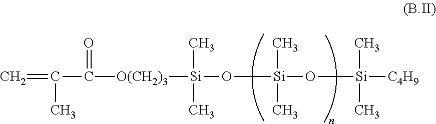
wherein n is an integer comprised from 3 to 15;
(C) is at least one selected from the group consisting of: (met) acrylic acid, α-chloro-acrylic acid, crotonic acid, maleic acid, fumaric acid and itaconic acid, monomers including a hydroxyl group, e.g. 2-hydroxyethyl (met)acrylate and 2-hydroxypropyl (met)acrylate, hydroxybutyl (met)acrylate, 3-chloro-2-hydroxypropyl methacrylate, poly(ethylene glycol) mono(meth)acrylate, poly(propylene glycol) mono(methacrylate), poly(ethylene glycol)-co-poly(propylene glycol) mono(methacrylate), polytetrahydrofuran mono(methacrylate), N-hydroxymethyl(methacrylamide), hydroxybutylvinyl ether, N-hydroxymethyl (meth)acrylamide, vinyl (meth)acrylate, allyl (meth)acrylate, N-methoxymethylacrylamide, N-isopropoxy-methylacrylamide, N-butoxy-methylacrylamide N-isobutoxy-methylacrylamide, glycidyl (meth)acrylate, 2-carboxyethyl acrylate, and (α,α-dimethyl-m-isopropenylbenzyl) isocyanate, alkyl (meth)acrylate compounds terminated with an isocyanate group blocked by phenol, ketoxime, pyrazole or mixtures thereof;
(D) is a compound of general formula (D.I): 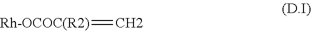
wherein:
R2 is hydrogen or methyl;
Rh is a benzyl radical or an alkyl radical, linear or branched, comprising from 1 to 30 carbon atoms;
(E) is a compound of general formula (E.I): 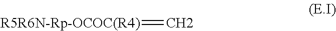
wherein:
R4 is hydrogen or methyl;
R^{p} is an alkylene radical comprising from 1 to 10 carbon atoms optionally substituted with at least one hydroxyl/or halogen group;
R5, R6 are independently hydrogen, a benzyl radical or an alkyl radical, linear or branched, comprising from 1 to 10 carbon atoms;
(F) is at least one selected from the group consisting of: vinyl acetate, vinyl propionate, vinyl isobutyrate, vinyl pivalate, vinyl 2-ethylhexanoate, vinyl stearate, N-vinyl pyrrolidinone, vinyl chloride, vinylidene chloride, trimethyl vinyl silane, trimethoxy vinyl silane, triethoxy vinyl silane, and mixtures thereof.

2. The polymer according to claim 1, wherein:
(A) is the compound of general formula (A.I);
(B) is the compound of general formula (B.I);
(C) is selected from 2-hydroxyethyl acrylate, 2-hydroxyethyl methacrylate, 2-hydroxypropyl acrylate, 2-hydroxypropyl methacrylate, hydroxybutyl acrylate, hydroxybutyl methacrylate, glycidyl methacrylate, acrylic acid, methacrylic acid, 2-carboxyethyl acrylate, and mixtures thereof;
(D) is at least one selected from the group consisting of: decyl (meth)acrylate, isobornyl (meth)acrylate, lauryl (meth)acrylate, stearyl (meth)acrylate, cyclohexyl (meth)acrylate, tridecyl (meth)acrylate, behenyl (meth)acrylate, a longer chain (meth)acrylate than C18, and mixtures thereof; or wherein (D) is stearyl (meth)acrylate, tridecyl methacrylate or mixtures thereof;
in the compound of general formula (E.I): Rp is an alkylene radical comprising from 2 to 5 carbon atoms, and R5, R6 are independently hydrogen or an alkyl radical, linear or branched, comprising from 1 to 5 carbon atoms.

3. The polymer according to claim 1, wherein (E) is selected from the group consisting of 2-dimethylamino ethyl (meth)acrylate, 2-diethylaminoethyl (meth)acrylate, 2-(tert-butylamino)ethyl (meth)acrylate, and mixtures thereof.

4. The polymer according to claim 1, wherein said polymer comprises or consists of:

| | | |
|---|---|---|
| (A.I) | (3-methacryloxy-2- | from 45% to |
| | hydroxypropoxy)propylbis(trimethylsiloxy) | 75% by weight |
| | methylsilane | |
| (B.I) | optionally 3- | from 5% to |
| | [tris(trimethylsiloxy)silyl]propyl | 22% by weight |
| | methacrylate | |
| (C) | 2-hydroxypropyl acrylate or 2- | from 1.5% to |
| | hydroxypropyl methacrylate or glycidyl | 17% by weight |
| | methacrylate, or methacrylic acid, or 2- | |
| | carboxyethyl acrylate, or a mixture of 2- | |
| | hydroxyethyl methacrylate and glycidyl | |
| | methacrylate, or a mixture of glycidyl | |
| | methacrylate and 2-hydroxyethyl | |
| | methacrylate, or a mixture of methacrylic | |
| | acid and 2-carboxyethyl acrylate; | |
| (D) | stearyl methacrylate, stearyl acrylate, | from 7% to |
| | tridecyl methacrylate, tridecyl acrylate, t- | 33% by weight |
| | butyl methacrylate, t-butyl acrylate, or any | |
| | combination thereof, or behenyl | |
| | (meth)acrylate, or a mixture of behenyl | |
| | (meth)acrylate and methyl (meth)acrylate; | |
| | stearyl methacrylate, or a mixture | |
| | of stearyl methacrylate and tridecyl | |
| | methacrylate, or behenyl (meth)acrylate, or | |
| | a mixture of behenyl (meth)acrylate and | |
| | methyl (meth)acrylate, or a mixture of butyl | |
| | (meth)acrylate and stearyl (meth)acrylate; | |
| (E) | optionally 2-dimethylamino ethyl acrylate | from 3% to |
| | or 2-dimethylamino ethyl methacrylate | 15% by weight |
| (F) | optionally N-vinyl pyrrolidinone or | from 0% to |
| | vinylidene chloride | 8% by weight |

5. The polymer according to claim 4, wherein said polymer comprises or consists of:

| | | |
|---|---|---|
| (A.I) | (3-methacryloxy-2- | from 45% to |
| | hydroxypropoxy)propylbis(trimethylsiloxy) | 75% by weight |
| | methylsilane | |
| (B.I) | optionally 3- | from 5% to |
| | [tris(trimethylsiloxy)silyl]propyl | 22% by weight |
| | methacrylate | |
| (C) | 2-hydroxypropyl methacrylate or | from 3% to |
| | methacrylic acid | 16% by weight |
| (D) | a mixture of stearyl methacrylate and | from 7.5% to |
| | tridecyl methacrylate, or stearyl | 23% by weight |
| | methacrylate, or a mixture of stearyl | |
| | methacrylate and butyl methacrylate | |
| (E) | 2-dimethylamino ethyl acrylate or 2- | from 3% to |
| | dimethylamino ethyl methacrylate | 15% by weight |

6. The polymer according to claim 4, wherein said polymer comprises or consists of:

| | | |
|---|---|---|
| (A.I) | (3-methacryloxy-2- | from 50% to |
| | hydroxypropoxy)propylbis(trimethylsiloxy) | 60% by weight |
| | methylsilane | |
| (B.I) | 3-[tris(trimethylsiloxy)silyl]propyl | from 7% to |
| | methacrylate | 19% by weight |
| (C) | a mixture of 2-hydroxyethyl methacrylate | from 1.5% to |
| | and glycidyl methacrylate; | 8% by weight |
| (D) | behenyl (meth)acrylate | from 20% to |
| | | 32% by weight |

7. The polymer according to claim 4, wherein said polymer comprises or consists of:

| | | |
|---|---|---|
| (A.I) | (3-methacryloxy-2- | from 50% to |
| | hydroxypropoxy)propylbis(trimethylsiloxy) | 60% by weight |
| | methylsilane | |
| (B.I) | 3-[tris(trimethylsiloxy)silyl]propyl | from 7% to |
| | methacrylate | 19% by weight |
| (C) | a mixture of 2-hydroxyethyl methacrylate | from 1.5% to |
| | and glycidyl methacrylate; | 8% by weight |
| (D) | a mixture of behenyl (meth)acrylate and | from 20% to |
| | methyl (meth)acrylate | 32% by weight |

8. A composition comprising the polymer according claim 1, and one or more technological additives, wherein said composition is a solution, a dispersion or an emulsion;
said one or more technological additives being selected from the following group:
(i) one or more polymers configured to obtain compositions with a wet effect, with greater abrasion resistance, /or with better adhesion on a substrate, or to obtain flame retardant, /or antibacterial, /or film-forming properties; or
(ii) a further polymer which may be silicone such as alkyl polysiloxane; or a paraffin with a melting point comprised from 40° C. to 100° C., or a blocked isocyanate; or
(iii) nanoparticles of oxides of silica/or cerium, titania, alumina, zirconia, or combinations thereof; or
(iv) any combination of (i)-(iii).

9. The composition according to claim 8, said nanoparticles (iii) having an average particle size distribution comprised from 1 nm to 100 nm, said average distribution being determined by dynamic laser light scattering.

10. A method comprising applying to a substrate a polymer according to claim 1 or of the composition as a water-repellent or oil-repellent agent, or as an anti-stain agent, or as an anti-graffiti agent;
wherein said substrate is selected from the group consisting of: paper, cardboard, natural fabrics, synthetic fabrics, carpets, leather, eco-leather, leather, construction materials; bricks, tiles, natural stone, reconstituted stone, ceramics, plasters, concretes, cements, mortars, wood, glass, metals and plastics.
